(19) United States
(12) Patent Application Publication
(10) Pub. No.: US 2011/0216009 A1
(43) Pub. Date: Sep. 8, 2011

(54) SNAP-ON KEYPAD FOR A WIRELESS HANDSET

(76) Inventors: Kwanghyun David Choi, Fullerton, CA (US); Susan McKinney, Encinitas, CA (US)

(21) Appl. No.: 12/716,172

(22) Filed: Mar. 2, 2010

(51) Int. Cl. G06F 3/02; G08B 6/00

(52) U.S. Cl. 345/169

(57) ABSTRACT

A wireless handset having a top housing with integrated keypad and method for navigating a wireless handset interface using the keypad is described. The wireless handset comprises a top housing having a plurality of tabs which mate with slots of a mating housing such that the break line between the top housing and the mating housing occurs on the sidewall of the wireless handset.

### FIELD

The present invention relates to a keypad for a wireless handset and a method for navigating a wireless handset interface. More particularly, the invention relates to a top housing with integrated keypad that may be connected to a mating housing in a manner such that the break line between the top housing and the lower housing is located on the sidewall of the wireless handset.

### BACKGROUND

It is desirable to have keypads integrated into the housing of wireless handsets such that there is no physical break between individual keys. Integrated keypads provide a clean appearance on the face of the phone. The lack of individual moving parts, as found in a conventional keypad, provides increased robustness.

A capacitive sensor system is often used to provide functionality for the keys of a keypad with keys that are contiguous with the housing of a wireless handset. However, a capacitive sensor system and its related components add significant cost and complexity to the handset. Thus, it is desirable to have an integrated keypad providing a clean handset surface appearance and robust functionality without the cost and complexity of a capacitive sensor system.

### SUMMARY

A wireless handset having a top housing with integrated keypad and method for navigating a wireless handset interface using the keypad is described. The wireless handset comprises a top housing having a plurality of tabs. The wireless handset further comprises a mating housing having slots that mate with the tabs of the top housing. A top housing includes a keypad that is integrated into the housing. When the top housing is connected to the mating housing, the break line between the top housing and the mating housing occurs on the sidewall of the wireless handset.

The wireless handset may also comprise a molded key component having at least one key and at least one tab extending beyond the key. The key of the molded key component may extend through an opening in the top housing. The molded key component is anchored in place between the top housing and the mating housing by the tab or tabs that extend beyond the key.

In another embodiment, the wireless handset may comprise a top housing and a mating housing. The wireless handset includes a means for integrating a keypad into the top housing. The wireless handset further includes means for attaching the top housing to the mating housing such that the break line between the top housing and the mating housing is on the sidewall of the wireless handset.

A method for navigating a wireless handset interface is also described. The method comprises operating a key located on a top housing of the wireless handset. The key is contiguous with the top housing, and provides tactile feedback to the user when it is operated. The top housing has a plurality of tabs that mate with a plurality of slots in a mating housing. When the top housing and the mating housing are connected, the break line between the top housing and the mating housing is on the sidewall of the wireless handset.

### DRAWINGS

The present invention will be more fully understood by reference to the following drawings which are for illustrative, not limiting, purposes.

FIG. 1 shows a perspective view of an illustrative wireless handset.

FIG. 2 shows a top plan view of an illustrative wireless handset with the main keypad deployed.

FIGS. 3A-3B show the anterior and posterior faces of an illustrative top housing.

FIG. 3C shows an exploded view of an illustrative top housing and an illustrative mating housing.

FIG. 3D shows a profile view of a tab of the top housing.

FIG. 4 shows an illustrative molded key component.

FIG. 5 shows an exploded view of an illustrative wireless handset.

FIG. 6 shows an illustrative communication system for the wireless handset.

### DETAILED DESCRIPTION

Persons of ordinary skill in the art will realize that the following description is illustrative and not in any way limiting. Other embodiments of the claimed subject matter will readily suggest themselves to such skilled persons having the benefit of this disclosure. It shall be appreciated by those of ordinary skill in the art that the wireless handset, systems, and methods described hereinafter may vary as to configuration and as to details.

A wireless handset having a top housing with integrated keypad and method for navigating a wireless handset interface using the keypad is described. The wireless handset may be, for example a slide phone, bar phone, or touchscreen phone. Those having ordinary skill in the art will recognize that the housing with integrated keypad described herein may be additionally be implemented in an MP3 player or other handheld electronic device.

The top housing has a plurality of tabs and a keypad that is integrated into the housing. The keypad may be contiguous with the housing, such that the keys of the keypad are not structurally separate from the housing. Icons on the surface of the top housing may be used to indicate the location of the keys.

The wireless handset also comprises a mating housing. The mating housing has a plurality of slots configured to mate with the tabs of the top housing. When the top housing is affixed to the mating housing, the break line between the top housing and the mating housing is on the sidewall of the wireless handset. Having the break line on the sidewall of the wireless handset gives the anterior face of the device a clean, unbroken appearance.

The wireless handset may have a molded key component comprising at least one key and at least one tab extending beyond the key. The top housing may have a slot shaped to receive the key, such that the key protrudes through the slot in the top housing. The top surface of the key may be flush with the surface of the top housing, preserving the clean appearance of the face of the device.

The top housing keypad may be assembled by placing the molded key component on top of the mating housing and then placing the top housing over the molded key component. When the top housing moves into its final assembled position, the tabs of the top housing are forced through the slots of the mating housing. When the tabs protrude through the slots, the top housing is secured. In other words, the top housing is “snapped” into place. In an embodiment with a molded key component, the molded key component is anchored in place between the top housing and the mating housing by the tabs that extend beyond the key that protrudes through an opening in the top housing.

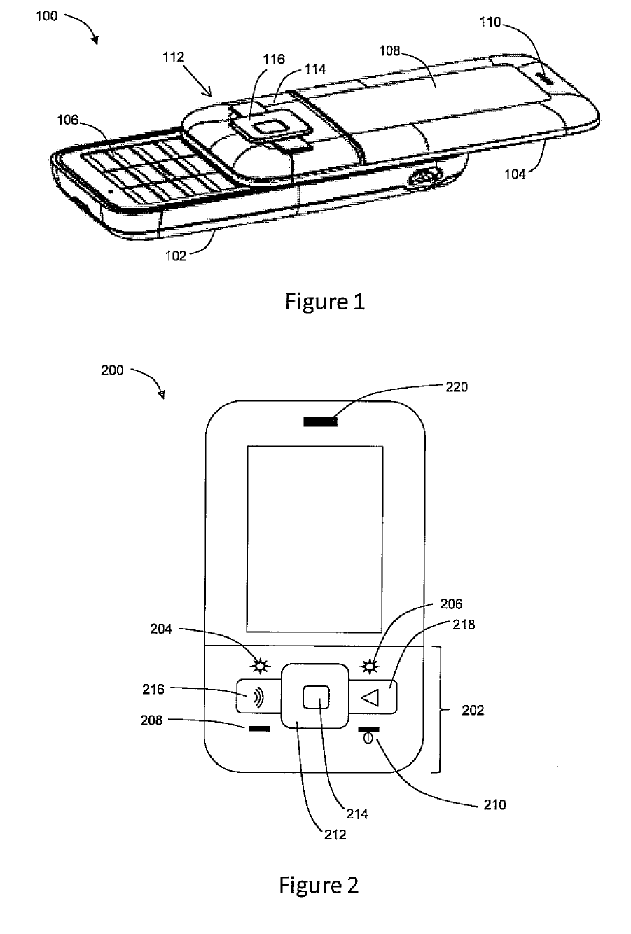

Referring now to FIG. 1, a perspective view of an illustrative wireless handset 100 is shown. The illustrative wireless handset can also be referred to as a wireless communication device, a mobile handset, mobile phone, wireless phone, portable cell phone, cellular phone, portable phone, a personal digital assistant (PDA), or any type of mobile terminal which is regularly carried by a user and has all the elements necessary for operation in a wireless communication system.

The illustrative wireless handset 100 is a slide phone having sections that slide relative to one another. Wireless handset 100 is shown with lower keypad section 102 deployed. Lower keypad section 102 has a lower keypad 106. In the illustrative embodiment shown, the keypad is a numeric keypad. The lower keypad may also be an alphanumeric keypad. Display section 104 has a display 108 and a speaker 110. The user may slide lower keypad section 102 toward display section 104 until the lower keypad section is completely covered by the display section. The lower keypad section is then secured in the retracted position behind the display section until the user deploys the lower keypad section again.

Wireless handset 100 also has top housing 112 comprising upper keypad 114. The upper keypad is shown with molded key component 116. The upper keypad 114 may be used both when the lower keypad section 102 is deployed and when the lower keypad section 102 is retracted behind the display section 104.

Referring to FIG. 2, a view in elevation of an illustrative wireless handset 200 is shown. In FIG. 2, lower keypad section 102 is fully retracted behind display section 104 such that only display section 104 is visible. Top housing 202 is shown. The top housing 202 includes a keypad comprising soft keys 204 and 206, send call key 208, and end call key 210. The locations of keys 204, 206, 208 and 210 are indicated by the icons shown on the top housing 202. The keys 204, 206, 208 and 210 are otherwise indistinguishable from the top housing, which presents a smooth, unbroken surface on the anterior face of the wireless handset 200.

Soft keys 204 and 206 are keys which may be programmed to perform different functions in different contexts, rather than being associated with a particular function. The soft key is typically adjacent to the display. The current functionality of the soft key is often indicated by text on the display positioned adjacent to the soft key.

Send call key or “send key” 208 may be used to initiate a call to a selected contact. End call key or “end key” 210 may be used to terminate a call in progress.

The wireless handset 200 also includes a molded key component comprising navigation key 212, enter key 214, speaker key 216 and back key 218. The molded key component also comprises a tab (not shown) that extends beyond the key portion shown. Keys 212-218 protrude through an opening in the top housing 202. The top surfaces of keys 212-218 of the molded key component may be level with the top surface of top housing 202 such that the device presents an even anterior surface.

Navigation key 212 features directional controls. The illustrative navigation key shown is a four-way directional control allowing the user to navigate up, down, left and right by pressing the upper, lower, left and right sections, respectively, of navigation key 214. The navigation key may alternatively feature two-way directional controls (up and down, or left and right) or more directional controls, such as an omnidirectional control.

Enter key 214 is shown in the center of navigation key 212. The enter key may be used, for example, to enter a selection or insert a carriage return in a block of text.

Speaker key 216 may be used to toggle between a speakerphone mode wherein the sound output is audible when the handset is held at a distance from the ear and a default mode wherein the sound output is audible when the user puts the speaker 220 to his or her ear.

Back key 218 may be used to move to a previous display on the display screen or a previous menu step in a user interface.

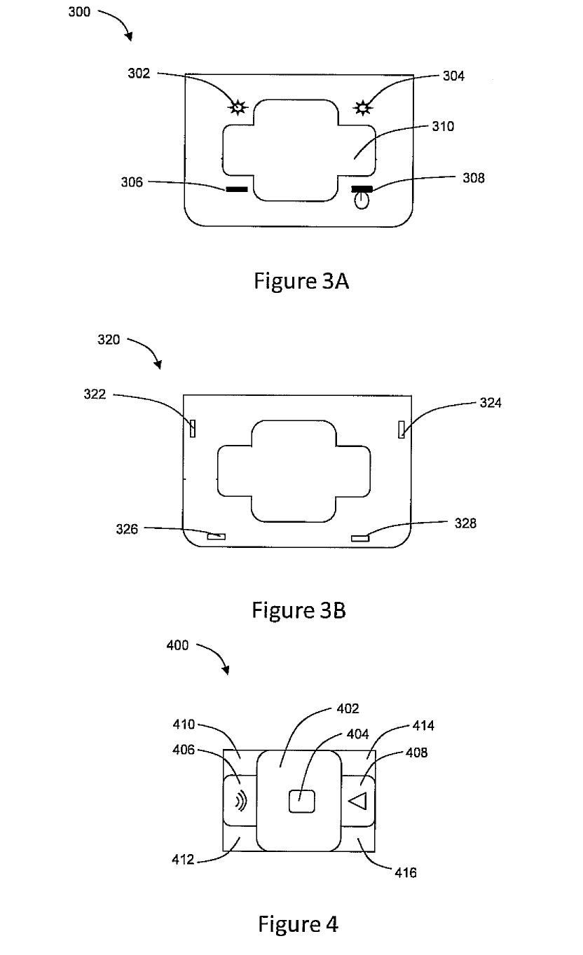

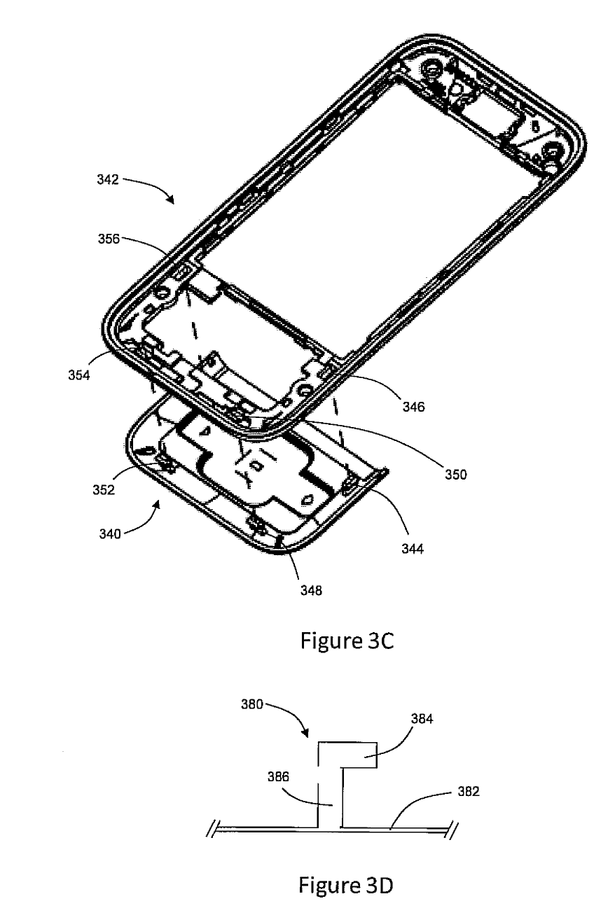

Referring to FIG. 3A, the anterior face 300 of an illustrative top housing is shown. FIG. 3B shows the posterior face 320 of the illustrative top housing.

FIG. 3A shows the top housing with icons indicating the locations of the top housing keys. The keypad of the illustrative top housing include soft keys 302 and 304, send key 306 and end key 308. Top housing 300 also has an opening 310 to receive the keys of the molded key component.

The top housing 300 may be a single molded component. The top housing may be formed of a flexible plastic material, such that the material is capable of flexing at the location of a key. When the key is pressed, the top housing flexes at the point of contact between the user's finger and the top housing. The depressed housing contacts a conductive dome, urging the conductive dome downward toward a printed circuit board (PCB). When the conductive dome contacts the printed circuit board, a circuit is completed and the function of the key is activated. The conductive dome may click perceptibly when it comes into contact with the PCB, such that the user receives tactile feedback when the key is pressed.

The posterior face may also have posts (not shown) at the locations of the top housing keys. When a key is pressed, the top housing flexes at the point of contact between the user's finger and the top housing. The post affixed to the top housing at the underside of the key moves downward, contacting a conductive dome. When the conductive dome contacts the printed circuit board, a circuit is completed and the function of the key is activated.

FIG. 3B shows the posterior face 320 of the top housing shown in FIG. 3A. Tabs 322, 324, 326 and 328 protrude from the posterior face of the top housing. The number and arrangement of tabs may vary as needed to secure the top housing to the mating housing.

Referring to FIG. 3C, an exploded view of illustrative top housing 340 and illustrative mating housing 342 are shown. Tab 344 of the top housing mates with slot 346 of the mating housing, tab 348 of the top housing mates with slot 350 of the mating housing, tab 352 of the top housing mates with slot 354 of the mating housing, and an additional tab of the top housing (not shown) mates with slot 356 of the mating housing.

Referring to FIG. 3D, an illustrative tab 380 of the top housing is shown in profile. A portion of the top housing surface is shown at 382. The tab comprises stem 386 that extends from the top housing surface 382. The tab further comprises an arm 384 that extends from stem 386. When the top housing is attached 340 to the mating housing 342, the stem 386 acts as a spring, forcing arm 384 of each tab through the slot of the mating housing, securing the top housing to the mating housing.

Referring to FIG. 4, an illustrative molded key component 400 is shown. The molded key component is fabricated as a single molded component. The molded key component is shown with navigation key 402, enter key 404, speaker key 406 and back key 408. The molded key component is further shown with tabs 410, 412, 414 and 416. The keys 402, 404, 406 and 408 extend through a slot in the top housing 340. The tabs 410, 412, 414 and 416 extend beyond the keys of the molded key component, anchoring the molded key component in place between the top housing 340 and the mating housing 342 when the top housing is attached to the mating housing.

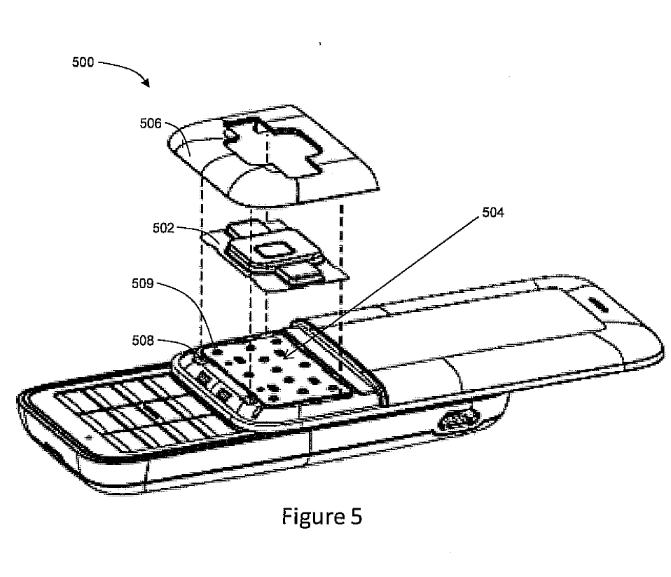

Referring to FIG. 5, an exploded view of an illustrative wireless handset 500 is shown. Molded key component 502 is placed on top of mating housing 504. Top housing 506 is then assembled to mating housing 504. The tabs (not shown) of top housing 506 mate with the slots of mating housing 504, such as the slot shown at 508.

The top housing 506 has a flat surface with curved edges, such that the flat surface is a part of the anterior face of the wireless handset and the curved edges are a part of the sidewalls of the wireless handset. When top housing 506 is attached to mating housing 504, the break line between the top housing and the mating housing is on the sidewall of the wireless handset, providing a clean unbroken appearance of the top housing on the anterior face of the wireless handset. A gap remains between the top housing and the mating housing at the break line, such that the keys of the top housing are operated by depressing the key over the distance of the gap. For example, the gap at the break line may range from 0.2 to 1.0 millimeters.

When a key is depressed, the lower surface of the key comes into contact with a metal dome, such as the metal dome shown at 509. When the key comes into contact with the metal dome, the metal dome is urged downward toward a PCB. Alternatively, a post may be affixed to the underside of the key. When the key is depressed, the post is moved downward into contact with a metal dome, urging the metal dome toward a PCB. When the metal dome contacts the PCB, a circuit is completed, causing the key function to be performed. A tactile response may be produced by the operation of the key, such that the user will know when a key has been operated.

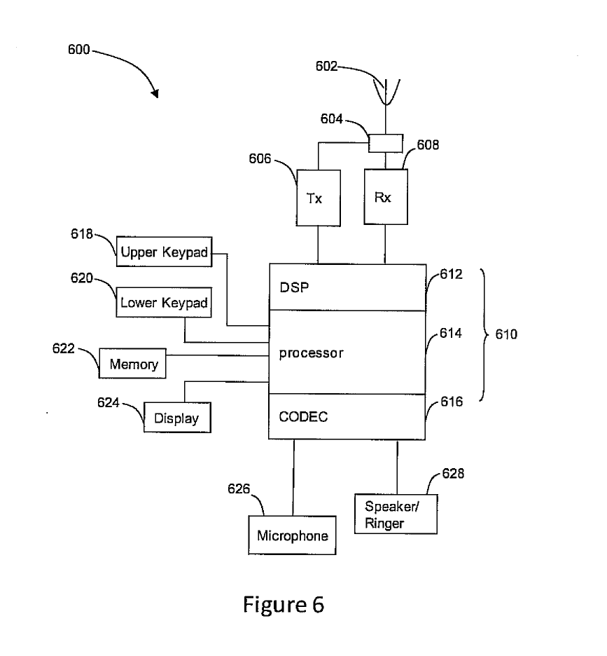

Referring to FIG. 6, there is shown a plurality of components associated with an illustrative wireless handset. The illustrative wireless handset 600 comprises a first antenna element 602 that is operatively coupled to a duplexer 604, which is operatively coupled to a transmitter module 606, and a receiver module 608.

An illustrative control module 610 comprises a digital signal processor (DSP) 612, a processor 614, and a CODEC 616 that are communicatively coupled to the transmitter 606 and receiver 608. It shall be appreciated by those of ordinary skill in the art that the transmitter module and receiver module are typically paired and may be embodied as a transceiver. The DSP 612 may be configured to perform a variety of operations such as controlling the antenna 602, the transmitter module 606, and the receiver module 608.

The processor 614 is operatively coupled to an upper keypad 618, lower keypad 620, memory 622, and display 624. As described above, the upper keypad 618 includes two soft key, a send call key, an end call key, a speaker key, a back key, and a navigation key, in which the navigation key provides four-way directional control with a navigation up key, a navigation down key, a navigation left key, a navigation right key, and also includes an enter key in the center of the navigation key. Thus, a total of 11 separate physical keys are represented by the upper keypad 618.

Additionally, the processor 607 is also operatively coupled to a CODEC module 616 that performs the encoding and decoding operations and is communicatively coupled to microphone 626 and a speaker or ringer 628. The CODEC module 616 is also communicatively coupled to the display 624 and provides the encoding and decoding operations for video.

A wireless handset having a top housing with integrated keypad and method for navigating a wireless handset interface using the keypad has been described above. Integrating the keypad into the top housing allows the break line between the top housing and a mating housing to occur on the sidewall of the wireless handset, providing a clean and robust interface design.

It is to be understood that the detailed description of illustrative embodiments are provided for illustrative purposes. The scope of the claims is not limited to these specific embodiments or examples. Therefore, various process limitations, elements, details, and uses can differ from those just described, or be expanded on or implemented using technologies not yet commercially viable, and yet still be within the inventive concepts of the present disclosure. The scope of the invention is determined by the following claims and their legal equivalents.

What is claimed is:

1. A wireless handset, comprising:
a top housing having a plurality of tabs;
a mating housing having slots positioned to mate with the tabs of the top housing;
a keypad integrated into the top housing, the keypad comprising at least one key;
wherein the break line between the top housing and the mating housing is on the sidewall of the wireless handset.

2. The wireless handset of claim 1, wherein the keypad comprises at least one key that is contiguous with the top housing.

3. The wireless handset of claim 2, wherein the key is capable of producing a tactile response when operated.

4. The wireless handset of claim 1, further comprising a molded key component, the molded key component comprising:
at least one key;
at least one tab, the tab extending beyond the key;
wherein the top housing has a slot to receive the key;
wherein the tab of the molded component anchors the plate between the top housing and the mating housing.

5. The wireless handset of claim 4, wherein the molded key component comprises a navigation key.

6. The wireless handset of claim 4, wherein the key of the molded key component is capable of producing a tactile response when operated.

7. The wireless handset of claim 4, wherein the surface of the key is flush with the surface of the upper housing.

8. The wireless handset of claim 1, further comprising:
a conductive dome located adjacent to each key;
a printed circuit board operatively coupled to each conductive dome;
wherein the conductive dome is urged toward the printed circuit board when a key is depressed;
wherein a circuit on the printed circuit board is completed when the conductive dome contacts the printed circuit board.

9. A wireless handset, comprising:
a top housing;
a mating housing;
a keypad comprising at least one key
a means for integrating the keypad into the top housing;
a means for affixing the top housing to the mating housing, wherein the break line between the top housing and the mating housing is on the sidewall of the wireless handset.

10. The wireless handset of claim 10, wherein the keypad comprises at least one key that is contiguous with the upper housing.

11. The wireless handset of claim 11, wherein the key is capable of producing a tactile response when operated.

12. The wireless handset of claim 10, further comprising a molded key component, the molded key component comprising:
at least one key;
at least one tab, the tab extending beyond the key;
wherein the upper housing has a slot to receive the key;
wherein the tab of the molded component anchors the molded component between the top housing and the mating housing.

13. The wireless handset of claim 12, wherein the molded key component comprises a navigation key.

14. The wireless handset of claim 12, wherein the key of the molded key component is capable of producing a tactile response when operated.

15. The wireless handset of claim 12, wherein the surface of the key is flush with the surface of the mating housing.

16. The wireless handset of claim 9, further comprising:
a conductive dome located adjacent to each key;
a printed circuit board operatively coupled to each conductive dome;
wherein the conductive dome is urged toward the printed circuit board when a key is depressed;
wherein a circuit on the printed circuit board is completed when the conductive dome contacts the printed circuit board.

17. A method for navigating a wireless handset interface, the method comprising:
operating a keypad integrated into a top housing of the wireless handset;
wherein the top housing has a plurality of tabs;
wherein a mating housing has a plurality of slots positioned to mate with the tabs of the top housing;
wherein the break line between the top housing and the mating housing is on the sidewall of the wireless handset.

18. The method of claim 17, further comprising operating a key of the keypad, the key contiguous with the top housing.

19. The method of claim 18, further comprising the key providing a tactile response when operated.

20. The method of claim 18, further comprising operating a key of a molded key component, the molded key component comprising:
at least one key;
at least one tab, the the tab extending beyond the key;
wherein the top housing has a slot to receive the key;
wherein the tab of the molded component anchors the plate between the top housing and the mating housing.

21. The method of claim 20, wherein the molded key component comprises a navigation key.

22. The method of claim 20, wherein the key of the molded key component provides a tactile response when operated.

23. The method of claim 18, wherein the operation of a key further comprises:
depressing the key, the downward movement of the key bringing it into contact with a metal dome located underneath the key;
urging a metal dome toward a printed circuit board;
completing a circuit when the metal dome contacts the printed circuit board.
